(19) United States
(12) Patent Application Publication
(10) Pub. No.: US 2025/0155314 A1
(43) Pub. Date: May 15, 2025

(54) SENSOR COMPARTMENT FOR LEAK DETECTION FOR AUTONOMOUS VEHICLES

(71) Applicant: Torc Robotics, Inc., Blacksburg, VA (US)

(72) Inventors: Carlo Elwinger, Maulbronn (DE); Fridtjof Stein, Ostfildern (DE); Chaitra Ashok Reddy, Bietigheim-Bissingen (DE)

(21) Appl. No.: 18/944,918

(22) Filed: Nov. 12, 2024

(30) Foreign Application Priority Data
Nov. 13, 2023 (DE) 102023131465.3

(51) Int. Cl. G01M 3/04; B60W 30/06; G07C 5/00

(52) U.S. Cl. CPC G01M 3/04; B60W 30/06; G07C 5/008

(57) ABSTRACT

The present disclosure relates to an autonomous vehicle comprising at least one sensor arranged within a chamber in the interior of the vehicle for detecting particles, moisture, and/or air pollution. An electronic control unit is provided for evaluating signals from the sensor, the electronic control unit having an evaluation unit which is configured to determine whether or not there is a leak. The electronic control unit has a communication unit which is configured to communicate with a backend via a wireless interface in order to report a detected leak. The electronic control unit also has a behavior module, which is configured to plan and control a driving behavior of the vehicle, wherein the evaluation unit is configured to control the behavior module to perform a maneuver for parking at a safe location upon detection of a leak with imminent danger.

### CROSS-REFERENCE TO RELATED APPLICATIONS

The present application claims priority to German Patent Application No. 102023131465.3, filed on Nov. 13, 2023, and titled “VEHICLE”, which is hereby incorporated by reference in its entirety.

### TECHNICAL FIELD

The present disclosure relates to an autonomous vehicle, and in particular an autonomous vehicle configured to detect leaks.

### BACKGROUND

Autonomous vehicles can drive in specific environmental conditions, such as moisture, air pollution (sandstorms), hot or cold environments.

Some substances, such as water and sand, can penetrate a control cabin and/or driver cabin, contaminate the cabin and destroy electronic components.

In the case of autonomous commercial vehicles, the load could also be contaminated or destroyed, for example if a trailer has a leak due to damage, such as a fallen rock.

In a non-autonomous vehicle, the driver is responsible for detecting leaks and reacting accordingly to minimize the damage.

IN202141004580 A describes that air pollution in closed vehicles is harmful to human lives and therefore it is very important to monitor air pollution in all types of closed, air-conditioned vehicles. A WSN-based vehicle system is proposed to measure the air pollution level in the closed air-conditioned vehicles with the help of a controller embedded in the sensors, to save human lives. The proposed WSN-based vehicle system monitors the N02, CO, moisture and temperature levels and detects movements using N02, CO, moisture, temperature and PIR sensors. The controller automatically opens the windows in the event of an anomaly detected due to gas leaks, temperature rise or movement due to the presence of a child or pet trapped in the car with the engine off. A warning message is automatically sent by the system to operators involved via a mobile app.

### BRIEF DESCRIPTION

The object of the present disclosure is to provide a new type of vehicle.

A vehicle is proposed, comprising at least one sensor arranged inside the vehicle for detecting particles and/or moisture and/or air pollution and an electronic control unit for evaluating signals from the at least one sensor, wherein the electronic control unit has an evaluation unit which is configured to use the signals to determine whether or not a leak is present. According to the present disclosure, the vehicle is designed as an autonomous vehicle, wherein the at least one sensor is arranged in a respective sensor chamber in order to detect leaks on the vehicle. The electronic control unit has a communication unit configured to communicate with a backend via a wireless interface to report a detected leak. The electronic control unit further comprises a behavior module configured to plan and control a driving behavior of the vehicle by controlling actuators of the vehicle for longitudinal and lateral control, wherein the evaluation unit is configured to control the behavior module to perform a maneuver to park at a safe location upon detection of a leak with imminent danger.

According to the present disclosure, sensors are proposed for autonomous vehicles for driving under difficult environmental conditions for detecting leaks through which harmful substances such as water, smoke, dust or sand can penetrate.

The leak detection made possible by the solution according to the present disclosure allows the user of the vehicle to react in good time in order to avoid further damage to the vehicle, in particular to the cabin, the body or the electronics. Furthermore, the solution according to the present disclosure can prevent corrosion caused by penetrating water or sand and corresponding operational failures, in particular of electronics damaged by water and/or sand. The early detection of leaks can avoid later costs. If the leak is not detected and stopped, water and sand can cause damage over time, resulting in considerable repair costs.

### BRIEF DESCRIPTION OF DRAWINGS

Exemplary embodiments of the present disclosure are explained in more detail below with reference to drawings.

In particular:

FIG. 1 shows a schematic view of an autonomous commercial vehicle,

FIG. 2 shows a schematic view of an autonomous passenger car,

FIG. 3 shows a schematic view of an electronic control unit of the autonomous vehicle.

Corresponding parts are provided with the same reference numerals in all figures.

### DETAILED DESCRIPTION

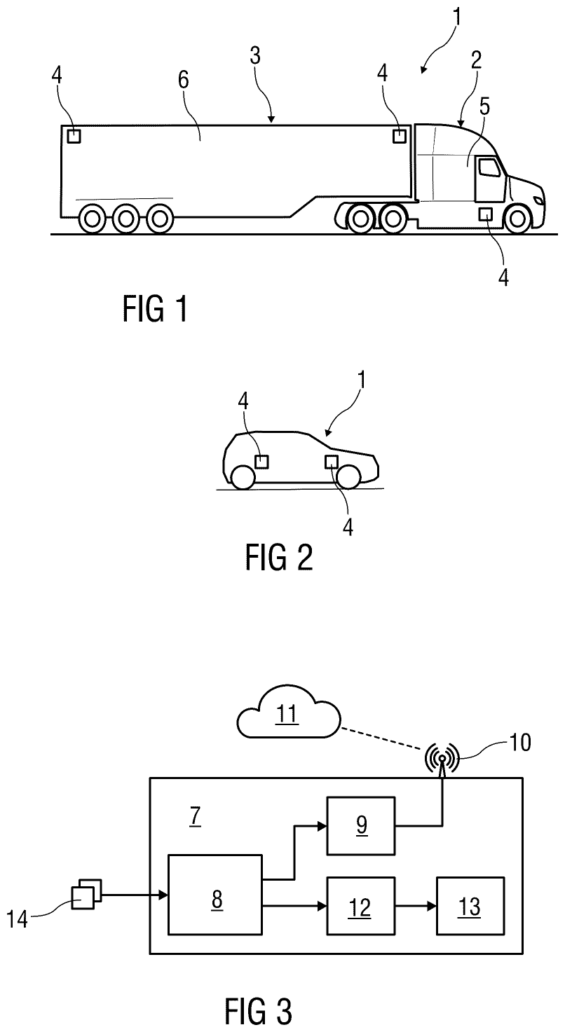

FIG. 1 is a schematic view of an autonomous vehicle 1, for example a commercial vehicle, comprising a tractor unit 2 and a semi-trailer 3 or trailer.

The autonomous vehicle 1 has at least one sensor 14 (shown in FIG. 3), for example at least one particle sensor and/or at least one moisture sensor and/or at least one air pollution sensor, which is arranged in a sensor chamber 4 or in a respective sensor chamber 4 in order to detect leaks through which the respective substance to be detected can penetrate into the interior of the vehicle 1. The at least one sensor chamber 4 is arranged inside the vehicle 1, for example inside a cabin 5 of the tractor unit or inside a body 6 of the semi-trailer 3 or trailer. In the exemplary embodiment shown in FIG. 1, one sensor chamber 4 is arranged in the cabin 5, a further sensor chamber 4 is arranged at a front upper corner of the body 6 and a further sensor chamber 4 is arranged at a rear upper corner of the body 6, as these corners are particularly exposed and therefore susceptible to damage.

FIG. 2 is a schematic view of an autonomous vehicle 1, for example a passenger car.

The autonomous vehicle 1 has at least one sensor 14 (shown in FIG. 3), for example at least one particle sensor and/or at least one moisture sensor and/or at least one air pollution sensor, which is arranged in a sensor chamber 4 or in a respective sensor chamber 4 in order to detect leaks through which the respective substance to be detected can penetrate into the interior of the vehicle 1. The at least one sensor chamber 4 is arranged inside the vehicle 1, for example inside a body of the vehicle 1.

FIG. 3 is a schematic view of an electronic control unit 7 arranged in the vehicle 1. The electronic control unit 7 is connected to the sensors 14 in the sensor chambers 4 in order to feed signals from the sensors 14 to the electronic control unit 7 and process them there.

The electronic control unit 7 has an evaluation unit 8, which uses the signals from the sensors 14 to determine whether there is a leak or whether the cabin 5 and/or the semi-trailer 3 or trailer is leak-proof, i.e. has no leak.

A communication unit 9 is also provided, which is configured to communicate with a backend 11 via a wireless interface 10 in order to report a detected leak. This message is available in the backend 11 for a user of the vehicle 1, who can then initiate appropriate measures.

Furthermore, the electronic control unit 7 has a behavior module 12 that can plan and control the driving behavior of the autonomous vehicle 1 by activating actuators 13 of the vehicle 1 for longitudinal and lateral control, for example accelerator, brakes and steering.

In the event of imminent danger from a detected leak, the behavior module 12 can perform a maneuver to park in a safe location.

If no leak was detected by the evaluation unit 8, this information can be provided in the backend 11. If a leak was detected by the evaluation unit 8, but the evaluation unit 8 does not detect any immediate danger, the information “no leak detected” can also be provided in the backend 11. If a leak with immediate danger was detected by the evaluation unit 8, the information “leak detected” can be provided in the backend 11 and a maneuver for parking in a safe location can be performed by the behavior module 12.

1. A vehicle, comprising at least one sensor arranged inside the vehicle each of the at least one sensor configured to detect a vehicle leak, and an electronic control unit configured to evaluate signals from the at least one sensor,
wherein the electronic control unit has an evaluation unit, which is configured to use the signals to determine whether or not there is a leak;
wherein the vehicle is configured to be an autonomous vehicle,
wherein the at least one sensor is arranged in a respective sensor chamber in order to detect leaks on the vehicle, the electronic control unit comprises a communication unit which is configured to communicate with a backend via a wireless interface in order to report a detected leak,
wherein the electronic control unit also has a behavior module, which is configured to plan and control a driving behavior of the vehicle by controlling longitudinal and lateral control actuators of the vehicle, and
wherein the evaluation unit is configured to control the behavior module to perform a parking maneuver at a safe location upon detection of a leak with imminent danger.

2. The vehicle according to claim 1, wherein the vehicle is designed as a commercial vehicle, and wherein the at least one sensor is arranged inside a cabin of a tractor.

3. The vehicle according to claim 1, wherein the vehicle is designed as a passenger car.

4. The vehicle according to claim 1, wherein the evaluation unit is configured to provide the information “no leak detected” in the backend when a leak is detected without immediate danger or when no leak is detected.

5. The vehicle of claim 1 wherein the at least one sensor detects a leak comprised of particles inside the vehicle.

6. The vehicle of claim 1 wherein the at least one sensor detects a leak comprised of moisture inside the vehicle.

7. The vehicle of claim 1 wherein the at least one sensor detects a leak comprised of air pollution inside of the vehicle.

8. The vehicle of claim 1 wherein the at least one sensor is comprised of a sensor to detect particles inside the vehicle, and/or a sensor to detect moisture inside the vehicle, and/or a sensor to detect air pollution inside the vehicle.

9. The vehicle of claim 1, wherein the at least one sensor chamber is arranged at a front portion of the body.

10. The vehicle of claim 9, wherein the at least one sensor chamber is arranged at a front upper corner of the body.

11. The vehicle of claim 1, wherein the at least one sensor chamber is arranged at a rear portion of the body.

12. The vehicle of claim 1, wherein the at least one sensor chamber is arranged at a rear upper corner of the body.

13. A method of controlling a vehicle, the method comprising:
acquiring data from at least one sensor, wherein the sensor is arranged within a respective sensor chamber;
sending the data via a signal to an electronic control unit, the electronic control unit comprising an evaluation unit;
determining, using the evaluation unit, whether the data indicates a leak; and
performing a parking maneuver using a behavior module of the electronic control unit when the evaluation unit determines a leak.

14. The method of claim 13, wherein behavior module is configured to activate actuators of the vehicle which control longitudinal and lateral vehicle movement.

15. The method of claim 13, wherein the at least one sensor is configured to detect particles.

16. The method of claim 13, wherein the at least one sensor is configured to detect moisture.

17. The method of claim 13, wherein the at least one sensor is configured to detect air pollution.

18. The method of claim 13, the method further comprising communicating, via a communication unit, the status of the leak to a backend which is available to a user of the vehicle.

19. The method of claim 18, wherein the communication unit communicates with the backend wirelessly.
